(19) United States
(12) Patent Application Publication
(10) Pub. No.: US 2012/0203993 A1
(43) Pub. Date: Aug. 9, 2012

(54) MEMORY SYSTEM WITH TIERED QUEUING AND METHOD OF OPERATION THEREOF

(75) Inventors: Theron Virgin, Gilbert, AZ (US); Ryan Jones, Mesa, AZ (US)

(73) Assignee: SMART STORAGE SYSTEMS, INC., Chandler, AZ (US)

(21) Appl. No.: 13/368,224

(22) Filed: Feb. 7, 2012

Related U.S. Application Data
(60) Provisional application No. 61/440,395, filed on Feb. 8, 2011.

(51) Int. Cl. G06F 12/02

(52) U.S. Cl. 711/165; 711/E12.002

(57) ABSTRACT

A method of operation of a memory system includes: providing a memory array having a dynamic queue and a static queue; and grouping user data by a temporal locality of reference having more frequently handled data in the dynamic queue and less frequently handled data in the static queue.

### CROSS-REFERENCE TO RELATED APPLICATION

This application claims the benefit of U.S. Provisional Patent Application Ser. No. 61/440,395 filed Feb. 8, 2011.

### TECHNICAL FIELD

The present invention relates generally to a memory system and more particularly to a system for utilizing wear leveling in a memory system.

### BACKGROUND

The rapidly growing market for portable electronic devices, e.g. cellular phones, laptop computers, digital cameras, memory sticks, and personal digital assistants (PDAs), is an integral facet of modern life. Recently, forms of long-term solid-state storage have become feasible and even preferable enabling smaller lighter and more reliable portable devices. When used in network servers and storage elements, these devices can offer much higher performance in bandwidth and IOPs over conventional rotating disk storage devices.

There are many non-volatile memory products used today, particularly in the form of small form factor cards, which employ an array of NAND flash cells (NAND flash memory is a type of non-volatile storage technology that does not require power to retain data) formed on one or more integrated circuit chips. As in all integrated circuit applications, the pressure to shrink the silicon substrate area required to implement some integrated circuits also exists with NAND flash memory cell arrays. There exists continual market pressure to increase the amount of digital data that can be stored in a given area of a silicon substrate. In order to increase the storage capacity of a given size memory card and other types of packages or to both increase capacity and decrease size and cost per bit. These market pressures to shrink manufacturing geometries produces a decrease overall performance of the NAND memory.

The responsiveness of flash memory cells typically changes over time as a function of the number of times the cells are erased, re-programmed, and read. This is thought to be the result of breakdown of a dielectric layer during erasing and re-programming or from charge leakage during reading and over time. This generally results in the memory cells becoming less reliable, and can require higher voltages or longer times for erasing and programming as the memory cells age.

The result is a limited effective lifetime of the memory cells; that is, memory cell blocks are subjected to only a preset number of erasing and re-programming cycles before they are no longer useable. The number of cycles to which a flash memory block can be subjected to depends upon the particular structure of the memory cells and the amount of the threshold window that is used for the storage states. The extent of the threshold window usually increasing as the number of storage states of each cell is increased.

Multiple access to a particular flash memory cell can cause that cell to lose charge and create faulty logic value on subsequent reads. Flash memory cells are also one time programmable, which requires data updates to be written into new areas of flash and old data to be consolidated and erased. It becomes necessary for the memory controller to monitor this data with respect to age and validity and to then free up additional memory cell resources by erasing old data. Memory cell fragmentation of valid and invalid data creates a state were new data to be stored can only be accommodated by combining multiple fragmented NAND pages into a smaller number of pages. This process is commonly called recycling. Currently there is no way to differentiate and organize data that is regularly rewritten (dynamic data) from data that is likely to remain constant (static data).

In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Thus, a need remains for memory systems with longer effective lifetimes and methods for operation. Solutions to these problems have been long sought but prior developments have not taught or suggested any solutions and, thus, solutions to these problems have long eluded those skilled in the art. Changes in the use and access methods for the NAND flash predicates changes in the algorithms used to manage NAND flash memory within a storage device. Shortened memory life and order of operations restrictions requires management level changes to continue to use the NAND flash devices without degrading the overall performance of the devices.

### DISCLOSURE OF THE INVENTION

The present invention provides a method of operation of a memory system, including: providing a memory array having a dynamic queue and a static queue; and grouping user data by a temporal locality of reference having more frequently handled data in the dynamic queue and less frequently handled data in the static queue.

The present invention provides a memory system, including: a memory array having: a dynamic queue, and a static queue coupled to the dynamic queue and with user data grouped by a temporal locality of reference having more frequently handled data in the dynamic queue and less frequently handled data in the static queue.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a block diagram of a memory system in an embodiment of the present invention.

FIG. 2 is a memory array block diagram of the memory system of FIG. 1.

FIG. 3 is a tiered queuing block diagram of the memory system of FIG. 1.

FIG. 4 is an erase pool block diagram of the memory system of FIG. 1.

FIG. 5 is a flow chart of a method of operation of the memory system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it will be apparent that the invention can be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. In addition, where multiple embodiments are disclosed and described having some features in common, for clarity and ease of illustration, description, and comprehension thereof, similar and like features one to another will ordinarily be described with similar reference numerals.

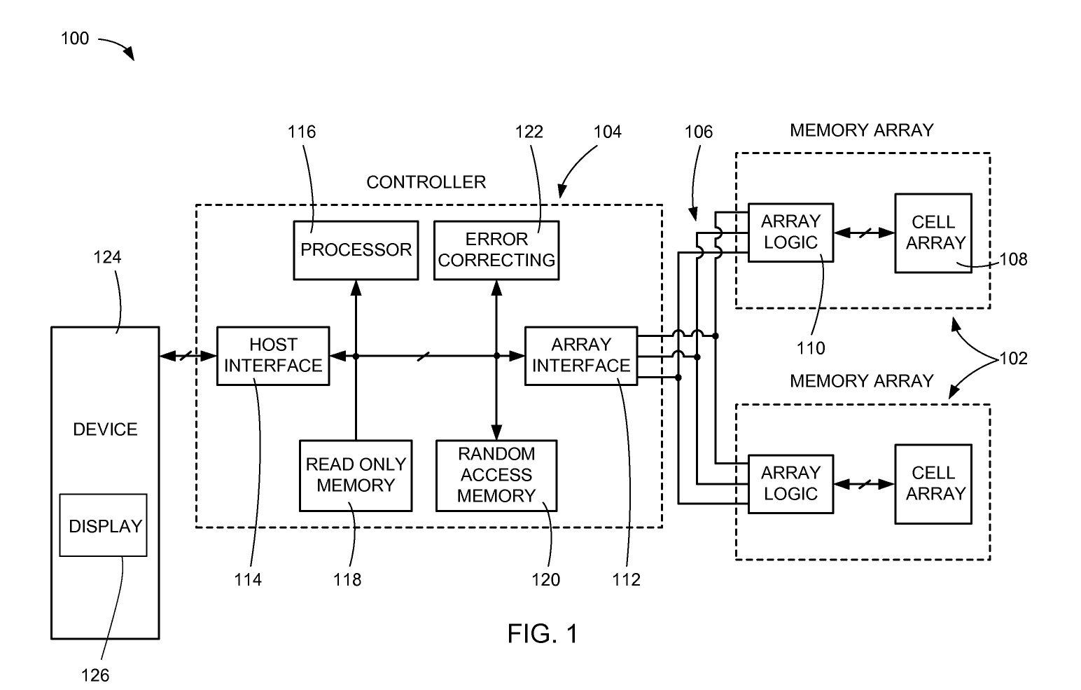

Referring now to FIG. 1, therein is shown a block diagram of a memory system 100 in an embodiment of the present invention. The memory system 100 is shown having memory array blocks 102 are coupled to a controller block 104, both representing physical hardware. In the example shown, the memory array blocks 102 are commutatively coupled and can communicate using serial, synchronous, full duplex communication protocol or other similar protocol with the controller block 104 with a bus 106. The memory array blocks 102 can be multiple individual units coupled together and to the controller block 104 or can be a single unit coupled to the controller block 104.

The memory array blocks 102 can have a cell array block 108 of individual, physical, floating gate transistors. The memory array blocks 102 can also have an array logic block 110 coupled to the cell array block 108 and can be formed on the same chip as the cell array block 108.

The array logic block 110 can further be coupled to the controller block 104 via the bus 106. For example, the controller block 104 can be on a separate integrated circuit chip (not shown) from the memory array blocks 102. In another example, the controller block 104 can be formed on the same integrated circuit chip (not shown) as the memory array blocks 102.

The array logic block 110 can represent physical hardware and provide addressing, data transfer and sensing, and other support to the memory array blocks 102. The controller block 104 can include an array interface block 112 coupled to the bus 106 and coupled to a host interface block 114. The array interface block 112 can include communication circuitry to ensure that the bus 106 efficiently utilized to send commands and information to the memory array blocks 102.

The controller block 104 can further include a processor block 116 coupled to the array interface block 112 and the host interface block 114. A read only memory block 118 can be coupled to the processor block 116. A random access memory block 120 can be coupled to the processor block 116 and to the read only memory block 118. The random access memory block 120 can be utilized as a buffer memory for temporary storage of user data being written to or read from the memory array blocks 102.

An error correcting block 122 can represent physical hardware and be coupled to the processor block 116 can run an error correcting code that can detect error in data stored or transmitted from the memory array blocks 102. If the number of errors in the data is less than a correction limit of the error correcting code the error correcting block 122 can correct the errors in the data, move the data to another location on the cell array block 108, and flag the cell array block 108 location for a refresh cycle.

The host interface block 114 of the controller block 104 can be coupled to device block 124. The device block 124 can include a display block 126 for visual depiction of real world physical objects on a display.

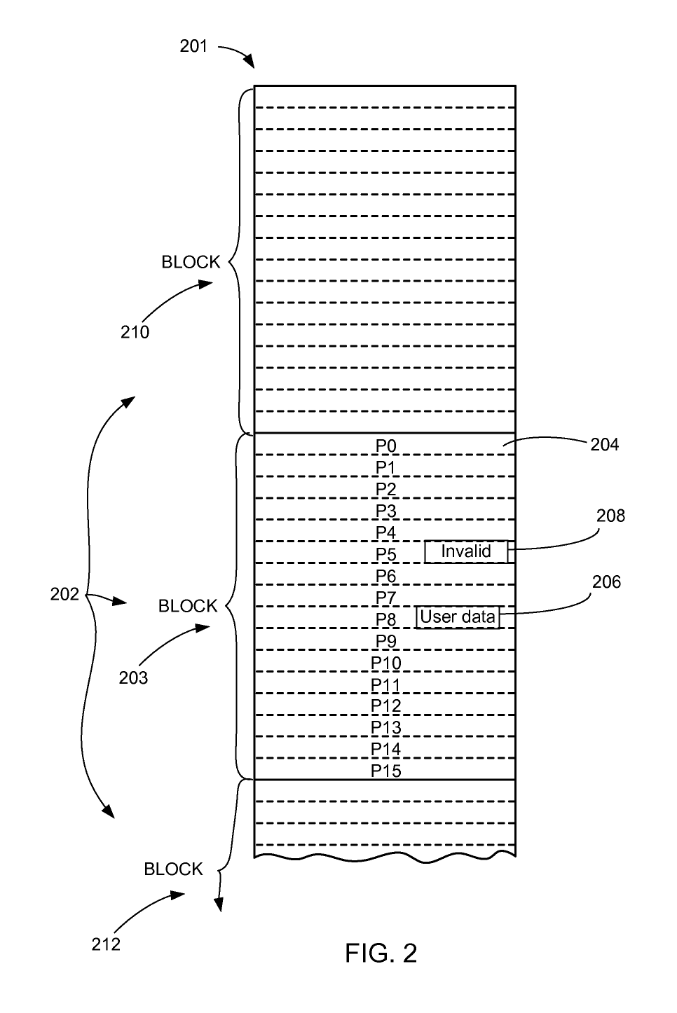

Referring now to FIG. 2, therein is shown a memory array block diagram 201 of the memory system 100 of FIG. 1. The memory array block diagram 201 can be part of or implemented on the cell array block 108 of FIG. 1. The memory array block diagram 201 can be shown having memory blocks 202 including a fresh memory block 203 representing a physical hardware array of memory cells. The fresh memory block 203 is defined as the minimum number of memory cells that can be erased together.

The fresh memory block 203 can be a portion of the memory array blocks 102 of FIG. 1. The fresh memory block 203 can include and be divided into memory pages 204. The memory pages 204 are defined as the minimum number of memory cells that can be read or programmed as a memory page. For example, the fresh memory block 203 is shown having the memory pages 204 (P0-P15) although the fresh memory block 203 can include fewer or more of the memory pages 204. The memory pages 204 can include user data 206.

For example, the fresh memory block 203 can be erased and all the memory cells within the fresh memory block 203 can be set to a logical 1. The memory pages 204 can be written by changing individual memory cells within the memory pages 204 to a logical 0. When the data on the memory pages 204 that have been written to needs to be updated the memory pages 204 can be updated by changing more memory cells to a logical 0. The more likely case, however, is that another of the memory pages 204 will be written with the updated information and the memory pages 204 with the previous information will be marked as an invalid memory page 208.

The invalid memory page 208 is defined as the condition of the memory pages 204 when data in the memory pages 204 is contained in an updated or current form on another of the memory pages 204. Within the fresh memory block 203 some of the memory pages 204 can be valid and others marked as the invalid memory page 208. The memory pages 204 marked as the invalid memory page 208 cannot be reused until the fresh memory block 203 is entirely erased.

The memory blocks 202 can also include a worn memory block 210 can be shown in an adjacent physical location as the fresh memory block 203. The worn memory block 210 is defined by having less usable read/write/erase cycles left in comparison to the fresh memory block 203. The memory blocks 202 can also include a freed memory block 212 can be shown in an adjacent physical location as the fresh memory block 203 and the worn memory block 210. The freed memory block 212 is defined as containing no valid pages or containing all erased pages.

It is understood that the non-volatile memory technologies are limited in the number of read and write cycles they can sustain before becoming unreliable. The worn memory block 210 can be approaching the technology limit of reliable read or write operations that have been performed. A refresh process can be performed on the worn memory block 210 in order to convert it to the freed memory block 212. The refresh process can include writing all zeroes into the memory and writing all ones into the memory in order to verify the stored levels.

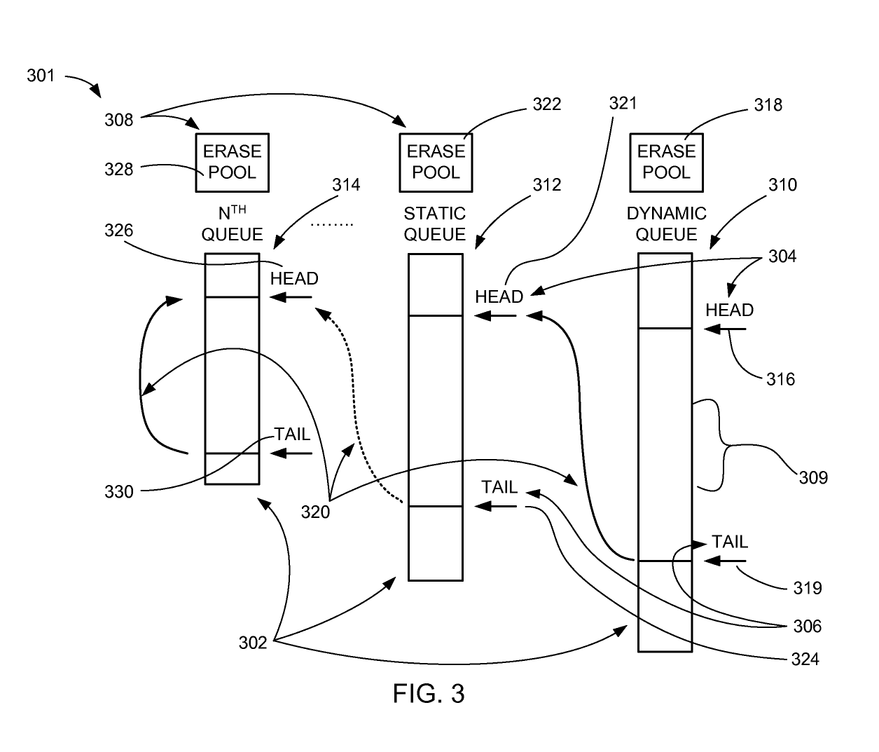

Referring now to FIG. 3, therein is shown a tiered queuing block diagram 301 of the memory system 100 of FIG. 1. The tiered queuing block diagram 301 can be implemented by and on the cell array block 108 of FIG. 1. The tiered queuing block diagram 301 is shown having circular queues 302 and can be located physically within the cell array block 108 of FIG. 1. The circular queues 302 can have head pointers 304, tail pointers 306, and erase pool blocks 308. The erase pool blocks 308 can physically reside within the array logic block 110 of FIG. 1 or the controller block 104 of FIG. 1.

Available memory space within each of the circular queues 302 can be represented by the space between the head pointers 304 and the tail pointers 306. Occupied memory space can be represented by the space outside of the head pointers 304 and the tail pointers 306.

The circular queues 302 can be arranged in tiers to achieve tiered circular queuing. Tiered circular queuing can group the circular queues 302 in series for grouping data based on a temporal locality 309 of reference. The temporal locality 309 is defined as the points in time of accessing data, either in reading, writing, or erasing; thereby allowing data to be grouped based on the location of the data in a temporal dimension in relation to the temporal location of other data. One of the circular queues 302 can be a dynamic queue 310. The dynamic queue 310 can be a designated group of memory locations on the memory array blocks 102 of FIG. 1 where frequently accessed data can be located. The dynamic queue 310 can also have the highest priority for recycling the memory blocks 202 of FIG. 2.

Another one of the circular queues 302 can be a static queue 312. The static queue 312 can be a designated group of memory locations on the memory array blocks 102 of FIG. 1 where less frequently accessed data can be located. The static queue 312 can have a lower priority for recycling the memory blocks 202 of FIG. 2. The circular queues 302 can have many more queues of lower priority for recycling the memory blocks 202 of FIG. 2 and less frequently accessed data. This can be represented by an n^{th} queue 314.

For example, new data can be written on the memory blocks 202 of FIG. 2 in the dynamic queue 310 that have been erased, regardless of where or whether the data was previously located in the circular queues 302. One of the head pointers 304 associated with the dynamic queue 310 can be a dynamic head 316. The dynamic head 316 can increment down the dynamic queue 310 by the number of the memory blocks 202 of FIG. 2 used to hold the new data. One of the erase pool blocks 308 associated with the dynamic queue 310 can be a dynamic pool block 318. The dynamic pool block 318 can register the usage of the memory blocks 202 of FIG. 2 used to hold the new data and can de-map them from the available blocks to be used for future data. The dynamic head 316 can be incremented each time new information is placed in the dynamic queue 310 and an insertion counter associated with the dynamic head 316 can be incremented when new data is written into the dynamic queue 310.

One of the tail pointers 306 associated with the dynamic queue 310 can be a dynamic tail 319. The dynamic tail 319 can be incremented downward, away from the dynamic head 316 when the memory blocks 202 of FIG. 2 are marked for deletion and allocated to the dynamic pool block 318. The dynamic tail 319 can be incremented once a demarcated number of writes in the dynamic queue 310 have been reached or exceeded. The dynamic tail 319 can also be incremented when a demarcated number of reads in the dynamic queue 310 have been reached or exceeded. The dynamic tail 319 can also be incremented when a demarcated number of the memory blocks 202 of FIG. 2 are available in the dynamic pool block 318. The circular queues 302 can also have thresholds 320. The dynamic tail 319 can also be incremented when the threshold 320 for incrementing the dynamic tail 319 is reached or exceeded based on the number of writes, number of reads, number of the memory blocks 202 of FIG. 2 available in the dynamic pool block 318 and the size of the dynamic queue 310 considered together or separately. The threshold 320 for the dynamic queue 310 can be: insertion_counter % threshold_{—}1==0 and can change dynamically.

When the threshold 320 to increment the dynamic tail 319 is reached or exceeded any of the memory pages 204 of FIG. 2 that are valid in the memory blocks 202 of FIG. 2 on the dynamic queue 310 will be written into the fresh memory block 203 of FIG. 2 associated with the static queue 312. The memory blocks 202 of FIG. 2 at the dynamic tail 319 will be designated by the dynamic pool block 318 to be erased and will be available to store new data in the dynamic queue 310.

One of the head pointers 304 associated with the static queue 312 can be a static head 321. When the valid memory at the dynamic tail 319 is transferred to the fresh memory block 203 of FIG. 2 on the static queue 312 the data will be placed at the static head 321 of the static queue 312. The static head 321 will be incremented by the number of the memory blocks 202 of FIG. 2 used to store the data from the dynamic queue 310. One of the erase pool blocks 308 associated with the static queue 312 can be a static pool block 322. The static pool block 322 can de-map the available the memory blocks 202 of FIG. 2 for future data from the static queue 312 by the amount of incrimination of the static head 321 and an insertion counter associated with the static head 321 can be incremented when new data is written into the static queue 312.

In another example, if the threshold 320 for the dynamic tail 319 to increment has been reached or exceeded and an entire one of the memory blocks 202 of FIG. 2 is valid, the memory blocks 202 of FIG. 2 can simply be assigned to the static queue 312 without re-writing the information and recycling the memory blocks 202 of FIG. 2. The assignment can occur if parameters of age of information on the memory block, number of write and read cycles indicate that read disturbs are unlikely.

It has been discovered that moving the memory blocks 202 of FIG. 2 that are entirely valid to the next lower priority queue can save time since the memory blocks 202 of FIG. 2 do not need to be erased. Further, it has been discovered that moving information from higher priority queues to lower priority queues allows the memory system 100 of FIG. 1 to develop a concept of determining static and dynamic data based solely on the historical longevity of the data in a queue. This determination has been found to provide the unexpected benefit that the memory controller can group static data together so that it will be less prone to fragmentation. This provides wear relief and speed increases as the memory controller, while doing recycling, can largely ignore these well-utilized memory cells. The concept of static and dynamic data based solely on historical longevity of the data within a queue has also been discovered to have the unexpected results of allowing greater flexibility to dynamically alter the way data is handled with very little overhead, which reduces cost per bit and integrated circuit die size.

It has yet further been discovered that utilizing the dynamic queue 310 and the static queue 312 allow the memory system 100 of FIG. 1 to determine the probability that data has changed based on the age of the data solely from the locality and grouping of data within the queues. Utilizing the static queue 312 further increases the longevity of the memory blocks 202 of FIG. 2 since static data or less frequently accessed data can be physically moved or conversely re-mapped to the static queue 312 with a lower priority of recycling the memory blocks 202 of FIG. 2.

The static head 321 will increment when data from the dynamic queue 310 is filtered down to the static queue 312. When data is filtered down the memory system 100 of FIG. 1 differentiates between static data accessed less frequently than dynamic data accessed more frequently. The distinction between static and dynamic data can be made with little overhead and can be used to increase efficiency by grouping dynamic data together so that it is readily accessible, while static data can be grouped together using less memory resources improving overall efficiency.

One of the tail pointers 306 associated with the static queue 312 can be a static tail 324. The static tail 324 can be incremented downward, away from the static head 321 when the memory blocks 202 of FIG. 2 are marked for deletion and allocated to the static pool block 322. The static tail 324 can be incremented once a demarcated number of writes in the static queue 312 have been reached or exceeded. The static tail 324 can also be incremented when a demarcated number of reads in the static queue 312 have been reached. The static tail 324 can also be incremented when a demarcated number of the memory blocks 202 of FIG. 2 are available in the static pool block 322. The static tail 324 can also be incremented when the threshold 320 for incrementing the static tail 324 is reached based on the number of writes, number of reads, number of the memory blocks 202 of FIG. 2 available in the static pool block 322 and the size of the static queue 312 considered together or separately. The threshold 320 for the static queue 312 can be: insertion_counter % threshold_{—}2==0 and can change dynamically.

When the threshold 320 to increment the static tail 324 is reached any of the memory pages 204 of FIG. 2 that are valid in the memory blocks 202 of FIG. 2 on the static queue 312 will be written into the fresh memory block 203 of FIG. 2 associated with the n^{th} queue 314. The memory blocks 202 of FIG. 2 at the static tail 324 will be designated by the static pool block 322 to be erased and will be available to store new data in the static queue 312.

While the static queue 312 is shown as a single queue, this is an example of the implementation and additional levels of the static queue 312 can be implemented. It is further understood that each subsequent level of the static queue 312 would reflect data that is modified less frequently than the previous level or than the dynamic queue 310.

One of the head pointers 304 associated with the n^{th} queue 314 can be an n^{th} head 326. When the valid memory at the static tail 324 is transferred to the fresh memory block 203 of FIG. 2 on the n^{th} queue 314 the data will be placed at the n^{th} head 326 of the n^{th} queue 314. The n^{th} head 326 will be incremented by the number of the memory blocks 202 of FIG. 2 used to store the data from the static queue 312. One of the erase pool blocks 308 associated with the n^{th} queue 314 can be an n^{th} pool block 328. The n^{th} pool block 328 can de-map the memory blocks 202 of FIG. 2 available for future data from the n^{th} queue 314 by the amount of incrimination of the n^{th} head 326 and an insertion counter associated with the n^{th} head 326 can be incremented when new data is written into the n^{th} queue 314.

In another example, new data can be written on the next highest priority queue. In this way data will move up the tiers in the circular queues 302 when it is changed. To illustrate, if data stored in the n^{th} queue 314 is changed, the memory blocks 202 of FIG. 2 in the n^{th} queue 314 is invalidated and the new data is written at the static head 321 of the static queue 312. In this way the data will work its way back up the queues. In contrast, any new data can also be written to the dynamic head 316 of the dynamic queue 310 regardless of where the data was previously grouped.

One of the tail pointers 306 associated with the n^{th} queue 314 can be an n^{th} tail 330. The n^{th} tail 330 can be incremented downward, away from the n^{th} head 326 when the memory blocks 202 of FIG. 2 are marked for deletion and allocated to the n^{th} pool block 328. The n^{th} tail 330 can be incremented once a demarcated number of writes in the n^{th} queue 314 have been reached. The n^{th} tail 330 can also be incremented when a demarcated number of reads in the n^{th} queue 314 have been reached. The n^{th} tail 330 can also be incremented when a demarcated number of the memory blocks 202 of FIG. 2 are available in the n^{th} pool block 328. The n^{th} tail 330 can also be incremented when the threshold 320 for incrementing the n^{th} tail 330 is reached based on the number of writes, number of reads, number of the memory blocks 202 of FIG. 2 available in the n^{th} pool block 328 and the size of the n^{th} queue 314 considered together or separately. The threshold for the dynamic queue 310 can be: insertion_counter % threshold_{—}3==0 and can change dynamically.

When the threshold 320 to increment the n^{th} tail 330 is reached any of the memory pages 204 of FIG. 2 that are valid in the memory blocks 202 of FIG. 2 on the n^{th} queue 314 will be written into the fresh memory block 203 of FIG. 2 associated with the n^{th} queue 314. The memory blocks 202 of FIG. 2 at the n^{th} tail 330 will be recycled, reconditioned and designated to the dynamic pool block 318.

The memory blocks 202 of FIG. 2 that have been freed or recycled are placed into the appropriate erase block pool based on the number of erases it has seen determined based on the highest number of erases any given erase block has seen. A percentage of the memory blocks 202 of FIG. 2 that are freed can be placed into the circular queues 302 having the next higher priority, while the remainder can be retained by the queue wherein it was last used. All of the memory blocks 202 of FIG. 2 freed from the circular queues 302 with the lowest priority, or the n^{th} queue 314 can be given to the circular queues 302 with the highest priority or the dynamic queue 310.

The memory blocks 202 of FIG. 2 with a fewer number of erases or a longer expected life can be associated with the dynamic queue 310 in the dynamic pool block 318 since the dynamic queue 310 will recycle the memory blocks 202 of FIG. 2 at a higher rate. The memory blocks 202 of FIG. 2 with a larger number of erases or a shorter expected life can be associated with the static queue 312 or the n^{th} queue 314 since the static queue 312 and the n^{th} queue 314 are recycled at a slower rate. If the erase pool blocks 308 of any of the circular queues 302 are empty the erase pool blocks 308 can borrow from an adjacent pool.

It has been discovered that leveraging the temporal locality 309 of reference by grouping the user data 206 of FIG. 2 into the circular queues 302 based on the frequency of modifications thereto improves the performance of SSD recycling by providing valuable time based groupings of the memory blocks 202 of FIG. 2 to improve wear leveling algorithms and efficiently identify the memory blocks 202 of FIG. 2 that need to be rewritten to avoid read and time induced bit flips. By categorizing data by frequency of use, the memory system 100 of FIG. 1 can then tailor its recycling algorithms to utilize the memory blocks 202 of FIG. 2 that are less used in the circular queues 302 that have a higher rate of recycling like the dynamic queue 310, while the user data 206 of FIG. 2 that is infrequently modified are allocated the memory blocks 202 of FIG. 2 with less lifespan.

It has further been discovered that the circular queues 302 arranged in circular tiers is able to determine frequency of using the user data 206 of FIG. 2 when the user data 206 of FIG. 2 makes its way to the end of the dynamic queue 310 and the user data 206 of FIG. 2 has not been marked obsolete, the memory system 100 of FIG. 1 recognizes that the user data 206 of FIG. 2 is less frequently written. If the user data 206 of FIG. 2 makes its way to the tail pointers 306 and it is still valid it is written at the head pointers 304 of the circular queues 302 of the next lower priority until it reaches the n^{th} queue 314, where it will stay until it is marked obsolete.

It has been discovered that the memory system 100 of FIG. 1 can distinguish between dynamic and static data without any information other than that collected by the circular queues 302. Grouping data based on its frequency of use allows the memory system 100 of FIG. 1 to leverage the temporal locality 309 of reference and allows the memory system 100 of FIG. 1 to treat the data blocks differently based on the chance that it has changed and consequently improve recycling performance.

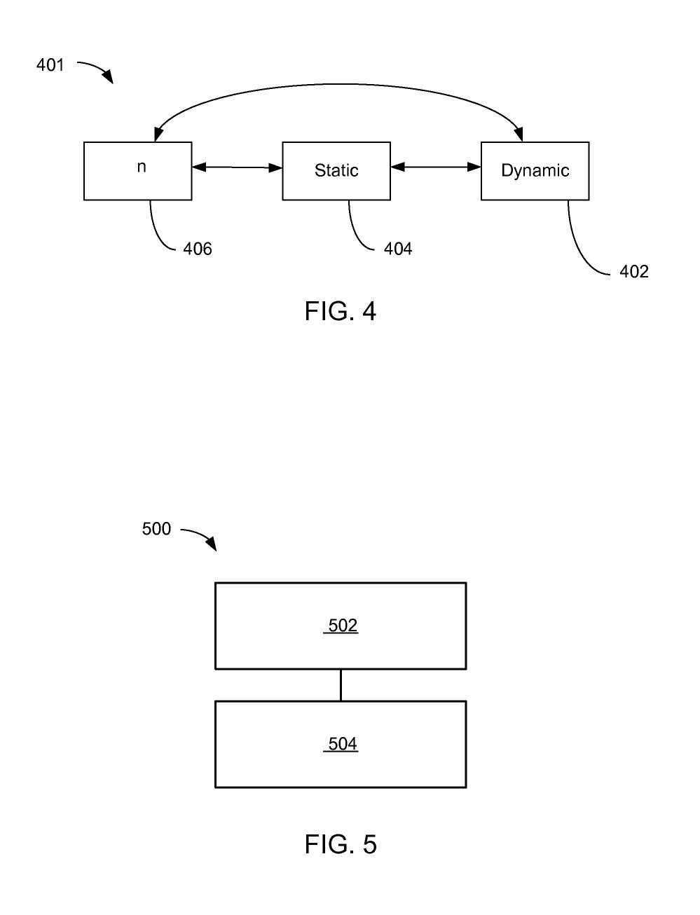

Referring now to FIG. 4, therein is shown an erase pool block diagram 401 of the memory system 100 of FIG. 1. The erase pool block diagram 401 can be associated with the circular queues 302 of FIG. 3. A dynamic pool block 402 can be associated with the dynamic queue 310 of FIG. 3 that handles the user data 206 of FIG. 2 that is frequently read, written, or erased. The dynamic queue 310 of FIG. 3 also has a priority for recycling the memory blocks 202 of FIG. 2 that contain invalidated pages.

The dynamic pool block 402 is coupled to a static pool block 404 that can be associated with the static queue 312 of FIG. 3, which handles the user data 206 of FIG. 2 that is less frequently read, written, or erased. The static queue 312 of FIG. 3 also has less priority for recycling the memory blocks 202 of FIG. 2 that contain invalidated pages.

The dynamic pool block 402 and the static pool block 404 can be coupled to an n^{th} pool block 406. The n^{th} pool block 406 can be associated with the n^{th} queue 314 of FIG. 3, which handles the user data 206 of FIG. 2 that is less frequently read, written, or erased than even the static queue 312 of FIG. 3. The n^{th} queue 314 of FIG. 3 also has a lower priority, even than the static queue 312 of FIG. 3, for recycling the memory blocks 202 of FIG. 2 that contain invalidated pages.

The erase pool blocks can allocate the memory blocks 202 of FIG. 2 that are freed among the dynamic queue 310 of FIG. 3, the static queue 312 of FIG. 3, or the n^{th} queue 314 of FIG. 3 based on the health of the memory blocks 202 of FIG. 2. If the memory blocks 202 of FIG. 2 are predicted or beginning to show signs of wear the memory blocks 202 of FIG. 2 can be allocated to one of the circular queues 302 of FIG. 3 with a lesser priority of recycling the memory blocks 202 of FIG. 2, such as the static queue 312 of FIG. 3 or the n^{th} queue 314 of FIG. 3. If the memory blocks 202 of FIG. 2 is freed from one of the circular queues 302 of FIG. 3 with a lower priority and it is predicted to or showing signs of greater relative usability or life span compared to one of the other the memory blocks 202 of FIG. 2, the memory blocks 202 of FIG. 2 that are freed can be allocated to the dynamic queue 310 of FIG. 3 by the dynamic pool block 402 and therefore allocating the memory blocks 204 of FIG. 2 that are healthy to the user data 206 of FIG. 2 that is dynamic and changing.

It has been discovered that utilizing the erase pool blocks to allocate the memory blocks 202 of FIG. 2 that are healthy to the user data 206 of FIG. 2 that is dynamic, and the memory blocks 202 of FIG. 2 that are more worn, to the user data 206 of FIG. 2 that is static, unexpectedly increases the lifespan of the memory system 100 of FIG. 1 as a whole by leveling the wear between the memory blocks 202 of FIG. 2 in an efficient way. It has been further discovered that utilizing the circular queues 302 of FIG. 3 coupled to the dynamic pool block 402, the static pool block 404, and the n^{th} pool block 406 unexpectedly enhances wear leveling of the memory system 100 of FIG. 1 since the memory blocks 202 of FIG. 2 are more efficiently matched to the user data 206 of FIG. 2 that is most suitable.

Referring now to FIG. 5, therein is shown a flow chart of a method 500 of operation of the memory system in a further embodiment of the present invention. The method 500 includes: providing a memory array having a dynamic queue and a static queue in a block 502; and grouping user data by a temporal locality of reference having more frequently handled data in the dynamic queue and less frequently handled data in the static queue in a block 504.

Thus, it has been discovered that the memory system and the tiered circular queues of the present invention furnishes important and heretofore unknown and unavailable solutions, capabilities, and functional aspects for memory system configurations. The resulting processes and configurations are straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a memory system comprising:
providing a memory array having a dynamic queue and a static queue; and
grouping user data by a temporal locality of reference having more frequently handled data in the dynamic queue and less frequently handled data in the static queue.

2. The method as claimed in claim 1 further comprising moving the user data from the dynamic queue to the static queue when a threshold of time per read has been reached, of available memory blocks for the dynamic queue has been reached, or a combination thereof.

3. The method as claimed in claim 1 further comprising:
recycling a worn memory block from the static queue; and
allocating the worn memory block to the dynamic queue or the static queue.

4. The method as claimed in claim 1 wherein:
providing the memory array includes providing the memory array having an n^{th} queue with a lower priority for recycling than the static queue and the dynamic queue; and
further providing:
recycling a freed memory block from the n^{th} queue to the dynamic queue.

5. The method as claimed in claim 1 further comprising remapping a fresh memory block of the dynamic queue to the static queue when a threshold is met or exceeded and the fresh memory block has no invalid memory pages.

6. A method of operation of a memory system comprising:
providing a memory array having a dynamic queue and a static queue;
grouping user data by a temporal locality of reference having more frequently handled data in the dynamic queue and less frequently handled data in the static queue for display of real world physical objects on a display block;
allocating a fresh memory block to the dynamic queue with a dynamic pool block; and
allocating a worn memory block to the static queue with a static pool block.

7. The method as claimed in claim 6 further comprising coupling a controller block to the memory array and the controller block physically containing the dynamic pool block and the static pool block.

8. The method as claimed in claim 6 further comprising recycling the fresh memory block or the worn memory block when all memory pages of the fresh memory block or the worn memory block are designated as invalid.

9. The method as claimed in claim 6 further comprising mapping new data to a dynamic head of the dynamic queue.

10. The method as claimed in claim 6 wherein:
providing the memory array includes providing the memory array having an n^{th} queue with a lower priority for recycling than the static queue and the dynamic queue; and
further comprising:
mapping updated data from the n^{th} queue to the static queue.

11. A memory system comprising:
a memory array having:
a dynamic queue, and
a static queue coupled to the dynamic queue and with user data grouped by a temporal locality of reference having more frequently handled data in the dynamic queue and less frequently handled data in the static queue.

12. The system as claimed in claim 11 wherein the memory array is for allocating the user data from the dynamic queue to the static queue when a threshold of time per read has been reached, of available memory blocks for the dynamic queue has been reached, or a combination thereof.

13. The system as claimed in claim 11 further comprising a worn memory block recycled from the static queue and allocated to the dynamic queue or the static queue.

14. The system as claimed in claim 11 wherein:
the memory array having an n^{th} queue therein and the n^{th} queue having a lower priority for recycling than the static queue and the dynamic queue; and
further comprising:
a freed memory block recycled from the n^{th} queue mapped to the dynamic queue.

15. The system as claimed in claim 11 further comprising a fresh memory block of the dynamic queue remapped to the static queue when a threshold is met or exceeded and the fresh memory block has no invalid memory pages.

16. The system as claimed in claim 11 further comprising:
a fresh memory block mapped to the dynamic queue;
a worn memory block mapped to the static queue;
a dynamic pool block for allocating the fresh memory block to the dynamic queue; and
a static pool block for allocating the worn memory block to the static queue.

17. The system as claimed in claim 16 further comprising a controller block coupled to the memory array and the controller block physically containing the dynamic pool block and the static pool block.

18. The system as claimed in claim 16 wherein the fresh memory block or the worn memory block are recycled when all memory pages of the fresh memory block or the worn memory block are designated as invalid.

19. The system as claimed in claim 16 wherein the dynamic queue has a dynamic head and new data is mapped to the dynamic head.

20. The system as claimed in claim 16 wherein the memory array includes an n^{th} queue therein, and the n^{th} queue having a lower priority for recycling than the static queue and the dynamic queue, and data contained on the n^{th} queue is placed in the static queue when updated.
